(19) United States
(12) Patent Application Publication
(10) Pub. No.: US 2024/0034889 A1
(43) Pub. Date: Feb. 1, 2024

(54) RESIN-COATED ALUMINUM ALLOY SHEET AND RESIN COMPOSITION FOR RESIN-COATED ALUMINUM ALLOY SHEET

(71) Applicant: UACJ Corporation, Tokyo (JP)

(72) Inventors: Hironori Watanabe, Tokyo (JP); Osamu Kato, Tokyo (JP)

(73) Assignee: UACJ Corporation, Tokyo (JP)

(21) Appl. No.: 18/279,618

(22) PCT Filed: Nov. 7, 2022
(86) PCT No.: PCT/JP2022/041343

§ 371 Date: Sep. 1, 2023

(30) Foreign Application Priority Data
Nov. 17, 2021 (JP) 2021-186860

(51) Int. Cl. C09D 7/61; C09D 163/00

(52) U.S. Cl. CPC C09D 7/61; C09D 163/00

(57) ABSTRACT

Provided is a resin-coated aluminum alloy sheet characterized in that the sheet has a coating resin layer formed of a cured resin composition comprising an epoxy resin and a curing agent, the coating resin layer comprising a graphite particle with an amount of 5.0 to 25.0 parts by mass relative to a total of 100.0 parts by mass of the epoxy resin and the curing agent and a silica particle with an amount of 3.0 to 28.0 parts by mass relative to a total of 100.0 parts by mass of the epoxy resin and the curing agent, and a thickness of the coating resin layer being 2.0 to 25.0 μm. According to the present invention, it is possible to provide the resin-coated aluminum alloy sheet having both a good heat radiative property and a high moisture resistance.

### TECHNICAL FIELD

The present invention relates to: a resin-coated aluminum alloy sheet having a processability, a heat radiation, and a high humidity resistance, useful as a material for a housing, a heat radiation sheet, a reflecting sheet, etc. for an electronic component, a home appliance, etc. that generate a heat; and a resin composition for the resin-coated aluminum alloy sheet, the composition being used to form a resin layer of the resin-coated aluminum alloy sheet.

### BACKGROUND ART

In accordance with the recent trend that an electronic device further decreases its size and becomes more sophisticated, a large heat can be generated locally from a component thereof. The increase in the heat generation from the component may impair the performance of electronic equipment and may also damage the reliability of the electronic equipment. Measures to quickly dissipate this heat to outside include a heat radiation measure using a ventilation hole and a heat radiation means using a cooling fan. Due to the energy necessary to drive the fan, however, these measures can cause problems that an environmental performance decreases because of an increase in CO₂ emission and that a cost thereof increases.

On the other hand, the cost of a heat radiation measure using a heat radiation is low because it does not require a power; and in addition, this not only has a high environmental performance because of a low noise caused by the fan but also has a merit of reducing the space for it. In this trend, a heat-dissipating resin-coated aluminum alloy sheet that is provided with a high heat radiation property has been proposed in which a surface of an aluminum alloy base material, which is the material having an excellent heat conductivity, is coated (Patent Literature 1). It is expected that the need for the heat-dissipating resin-coated aluminum alloy sheet will increase furthermore in the future.

As a low-cost material having good processability and heat radiative property, a heat-radiating surface treatment material that has an outer coating film and an inner coating film on the surface of a base material made of a metal or other material has been proposed, in which the inner coating film is a film comprising a pigment having a thermal emissivity of 70% or more with the amount of 0.03 to 70 mass % relative to the dry mass of the inner coating film (Patent Literature 2). However, in the aluminum alloy sheet coated with the resin such as the one proposed in Patent Literature 2, the resin has a tendency of being readily softened, so that when the aluminum alloy sheet is wound around and stored in the form of a coil during manufacturing thereof, the phenomenon that the resin coating films adhere to each other, i.e., a blocking phenomenon, can occur thereby causing a problem.

To overcome this problem, a heat-dissipating resin-coated aluminum alloy sheet that achieves an excellent heat radiation, and is yet resistant to cause the blocking phenomenon and has an excellent processability has been proposed (Patent Literature 3). However, because the coating film of Patent Literature 3 uses the resin that is susceptible to be hydrolyzed, the coating film can deteriorate in a high humidity environment. Selection of the resin that does not undergo the hydrolysis has also been studied, but due to the low emissivity of the resin itself, it has been very difficult to satisfy both the heat radiative property and the durability in a high humidity environment (humidity resistance).

### CITATION LIST

### Patent Literature

Patent Literature 1: Japanese Patent Publication 2014-201001-A
Patent Literature 2: Japanese Patent Publication 2002-228085-A
Patent Literature 3: Japanese Patent Publication 2005-305993-A

### SUMMARY OF INVENTION

### Technical Problem

An object of the present invention is to provide a resin-coated aluminum alloy sheet having both a good heat radiative property and a high humidity resistance.

### Solution to Problem

The inventors of the present invention carried out an extensive investigation, and as a result, it was found that when a chemical conversion coating film is formed on an aluminum alloy sheet followed by forming on it a coating resin layer formed of a cured resin composition comprising an epoxy resin, a curing agent, a predetermined amount of a graphite particle, and a predetermined amount of a silica particle, it was possible to improve the high humidity resistance furthermore without deteriorating the heat radiative property. The present invention was completed on the basis of this finding.

It is possible to solve the problems mentioned above by the present invention described below.

Namely, the present invention (1) provides a resin-coated aluminum alloy sheet characterized in that the sheet has a coating resin layer formed of a cured resin composition comprising an epoxy resin and a curing agent, the coating resin layer comprising a graphite particle with an amount of 5.0 to 25.0 parts by mass relative to a total of 100.0 parts by mass of the epoxy resin and the curing agent and a silica particle with an amount of 3.0 to 28.0 parts by mass relative to a total of 100.0 parts by mass of the epoxy resin and the curing agent, and a thickness of the resin coating layer being 2.0 to 25.0 μm.

In addition, the present invention (2) provides the resin-coated aluminum alloy sheet according to (1), characterized in that the coating resin layer is formed of a cured resin composition comprising, as a resin component, the epoxy resin and the curing agent, and as a filler, the graphite particle with an amount of 5.0 to 25.0 parts by mass relative to a total of 100.0 parts by mass of the epoxy resin and the curing agent and the silica particle with an amount of 3.0 to 28.0 parts by mass relative to a total of 100.0 parts by mass of the epoxy resin and the curing agent.

In addition, the present invention (3) provides the resin-coated aluminum alloy sheet according to (1) or (2), characterized in that a molecular weight of the epoxy resin is in the range of 40000 to 60000.

In addition, the present invention (4) provides the resin-coated aluminum alloy sheet according to any of (1) to (3), characterized in that the curing agent is an amino resin type curing agent.

In addition, the present invention (5) provides the resin-coated aluminum alloy sheet according to any of (1) to (4), characterized in that a thickness of the coating resin layer is in the range of 5.0 to 15.0 μm.

In addition, the present invention (6) provides the resin-coated aluminum alloy sheet according to any of (1) to (5), characterized in that an average particle size of the graphite particle is in the range of 1.0 to 8.0 μm.

In addition, the present invention (7) provides the resin-coated aluminum alloy sheet according to (6), characterized in that the average particle size of the graphite particle is in the range of 1.0 to 5.0 μm.

In addition, the present invention (8) provides the resin-coated aluminum alloy sheet according to any of (1) to (7), characterized in that an arithmetic mean roughness Ra of a surface of the coating resin layer is in the range of 0.100 to 2.500 μm.

In addition, the present invention (9) provides the resin-coated aluminum alloy sheet according to any of (1) to (8), characterized in that a glossiness of the coating resin layer is in the range of 0.1 to 4.5.

In addition, the present invention (10) provides a resin composition for a resin-coated aluminum alloy sheet, characterized in that the composition comprises an epoxy resin, a curing agent, a graphite particle with an amount of 5.0 to 25.0 parts by mass relative to a total of 100.0 parts by mass of the epoxy resin and the curing agent, a silica particle with an amount of 3.0 to 28.0 parts by mass relative to a total of 100.0 parts by mass of the epoxy resin and the curing agent, and a solvent.

### Advantageous Effects of Invention

According to the present invention, it is possible to provide the resin-coated aluminum alloy sheet having both a good heat radiative property and a high moisture resistance.

### BRIEF DESCRIPTION OF DRAWING

FIG. 1 is a schematic cross-sectional view of an embodiment example of the resin-coated aluminum alloy sheet according to the present invention.

### DESCRIPTION OF EMBODIMENTS

The resin-coated aluminum alloy sheet according to the present invention is characterized in that the sheet has a coating resin layer formed of a cured resin composition comprising an epoxy resin and a curing agent, the coating resin layer comprising a graphite particle with an amount of 5.0 to 25.0 parts by mass relative to a total of 100.0 parts by mass of the epoxy resin and the curing agent and a silica particle with an amount of 3.0 to 28.0 parts by mass relative to a total of 100.0 parts by mass of the epoxy resin and the curing agent, and a thickness of the coating resin layer being 2.0 to 25.0 μm. The resin-coated aluminum alloy sheet according to the present invention is a heat-dissipating resin-coated aluminum alloy sheet having a heat radiative property.

The resin-coated aluminum alloy sheet according to the present invention comprises the aluminum alloy sheet having on the surface thereof, either directly or via a chemical conversion coating film, the coating resin layer formed of the cured resin composition comprising the epoxy resin, the curing agent, the graphite particle, and the silica particle.

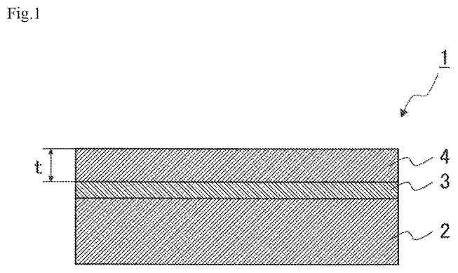

The resin-coated aluminum alloy sheet according to the present invention will be explained with referring to FIG. 1. FIG. 1 is a schematic cross-sectional view of an embodiment example of the resin-coated aluminum alloy sheet according to the present invention. In FIG. 1, a resin-coated aluminum alloy sheet 1 is formed of a chemical conversion coating film 3 formed on the surface of an aluminum alloy sheet (aluminum sheet) 2 and a coating resin layer 4 formed on the surface of the chemical conversion coating film 3. The resin-coated aluminum alloy sheet of the embodiment example illustrated in FIG. 1 has the chemical conversion coating film as a foundation for the coating resin layer. In the present invention, however, the chemical conversion coating film is optional; so, the coating resin layer may be formed directly on the surface of the aluminum alloy sheet (aluminum sheet). For example, the coating resin layer may be formed directly on the surface of the aluminum alloy sheet (aluminum sheet) that has been cleaned with an organic solvent, an alkali, or an acid. As for the resin-coated aluminum alloy sheet according to the present invention, there may be cited (i) the resin-coated aluminum alloy sheet that is formed of the aluminum alloy sheet (including an aluminum sheet), the chemical conversion coating film formed on the surface of the aluminum alloy sheet, and the coating resin layer formed on the surface of the chemical film, and (ii) the resin-coated aluminum alloy sheet that is formed of the aluminum alloy sheet (for example, the aluminum sheet that has been cleaned with an organic solvent, an alkali, or an acid) (including an aluminum sheet) and the coating resin layer formed on the surface of the aluminum alloy sheet. Illustrative examples of the organic solvent used for cleaning the aluminum alloy sheet include acetone, methylene chloride, and methyl ethyl ketone; and illustrative examples of the alkali include an aqueous sodium hydroxide solution and a commercially available degreasing solution for aluminum (including an alkali builder, a chelating agent, and a surfactant); and illustrative examples of the acid include nitric acid and sulfuric acid.

### (Aluminum Alloy Sheet)

The aluminum alloy sheet relating to the resin-coated aluminum alloy sheet according to the present invention is a sheet made of either aluminum or an aluminum alloy. The material of aluminum alloy sheet is not particularly restricted, although preferable are 1000 series aluminum materials, 3000 series aluminum alloy materials, and 5000 series aluminum alloy materials. The thickness of the aluminum alloy sheet may be chosen as appropriate in accordance with the use thereof; nevertheless, a range of 0.6 to 2.0 mm is preferable, and a range of 1.0 to 1.5 mm is more preferable.

### (Chemical Conversion Coating Film)

The resin-coated aluminum alloy sheet according to the present invention may or may not have a chemical conversion coating film on the aluminum alloy sheet. When the resin-coated aluminum alloy sheet according to the present invention has a chemical conversion coating film, the chemical conversion coating film is formed on the surface of the aluminum alloy sheet before forming the coating resin layer on the aluminum alloy sheet.

Although there is no particular restriction, the chemical conversion coating film is preferably a chromate type chemical conversion coating film treated with a phosphate chromate solution and a non-chromate type chemical conversion coating film that is formed by treating with a non-chromate solution by taking an environmental issue into consideration. There is no particular restriction in the non-chromate type chemical conversion coating film; nevertheless, a zirconium phosphate type chemical conversion coating film or a zirconium-molybdenum type chemical conversion coating film is preferable.

The coating amount of Cr or Zr in the chemical conversion coating film may be measured by an X-ray fluorescence analysis method. When the chemical conversion coating film comprises Cr, the coating amount of Cr is preferably in the range of 5 to 45 mg/m² in terms of the Cr atom. When the chemical conversion coating film comprises Zr, the coating amount of Zr film is preferably in the range of 0.5 to 15 mg/m² in terms of the Zr atom. When the coating amount of Cr in terms of the Cr atom is less than 5 mg/m², or when the coating amount of Zr in terms of the Zr atom is less than 0.5 mg/m², a corrosion resistance can be insufficient, and when the coating amount of Cr in terms of the Cr atom is more than 45 mg/m², or when the coating amount of Zr in terms of the Zr atom is more than 15 mg/m², processing adhesion can be insufficient.

When forming the chemical conversion coating film on the aluminum alloy sheet, it is preferable to carry out a degreasing treatment in order to remove contaminants from the surface of the aluminum alloy sheet and to control the surface condition. The degreasing is carried out preferably by using an alkali cleaning, for example, using caustic soda, sodium phosphate, sodium silicate, or the like. The degreasing using the alkali cleaning is carried out by spraying a predetermined surface treatment solution to the aluminum alloy sheet or by immersing the aluminum alloy sheet in the surface treatment solution at a predetermined temperature and for a predetermined time. After the alkaline cleaning, it is preferable to carry out an acid cleaning in order to remove a smut that is generated by the alkali cleaning. There is no particular restriction in the acid; nevertheless, for example, sulfuric acid and nitric acid may be used, in which sulfuric acid of 0.5 to 5.0 mass % is especially preferable.

Next, the surface of the degreased aluminum alloy sheet is chemically treated to form the chemical conversion coating film on the surface of the aluminum alloy sheet. The chemical treatment includes immersing the degreased aluminum alloy sheet in a phosphate chromate treatment solution, or in a non-chromate treatment solution, at a predetermined temperature and for a predetermined time, and spraying a phosphate chromate treatment solution, a non-chromate treatment solution, or the like to the degreased aluminum alloy sheet, which is then followed by drying the sheet thus treated.

### (Coating Resin Layer)

The resin-coated aluminum alloy sheet according to the present invention has a coating resin layer on the surface of the aluminum alloy sheet, either directly or via the chemical conversion coating film. The coating resin layer relating to the resin-coated aluminum alloy sheet according to the present invention is formed of the cured resin composition comprising the epoxy resin and the curing agent. In other words, the coating resin layer relating to the resin-coated aluminum alloy sheet according to the present invention is obtained by curing the resin composition comprising the epoxy resin and the curing agent. In addition, the coating resin layer, which is formed of the cured resin composition comprising the epoxy resin and the curing agent, comprises a graphite particle and a silica particle.

There is no particular restriction in the epoxy resin as long as this is a thermosetting epoxy resin capable of being cured by a curing agent to form a resin layer. As for the epoxy resin, there may be cited, for example, an epoxy resin that is glassy at room temperature. In addition, examples of the epoxy resin include a bisphenol A type, a bisphenol F type, and a novolac type, as well as those synthesized using an amine or a carboxylic acid. The epoxy resin contributes to a moisture resistance of the resin-coated aluminum alloy sheet so that it is possible to realize a high moisture resistance. The number-average molecular weight of the epoxy resin is preferably in the range of 40000 to 60000. When the number-average molecular weight of the epoxy resin is less than 40000, the processability can be poor. When the number-average molecular weight of the epoxy resin is more than 60000, the coating property can be poor. In the present invention, the number-average molecular weight is measured using a gel permeation chromatography (GPC).

The curing agent is a curing agent for the epoxy resin, in which an amino resin type curing agent may be cited for this. Illustrative examples of the amino resin type curing agent include compounds having a urea skeleton, such as urea and a urea derivative; compounds having a guanamine skeleton such as guanamine, methylated benzoguanamine, butylated benzoguanamine, methylbutylated benzoguanamine, and ethylated benzoguanamine; and compounds having a melamine skeleton, such as melamine, methylated melamine, butylated melamine, and butylmethylated melamine.

As for the graphite particle, there may be cited a material having a function to radiate an infrared light; illustrative examples thereof include a known material having a function to radiate an infrared light. When the coating resin layer comprises the graphite particle, the coating resin layer is provided with the heat radiative property. As for the graphite particle, there may be cited the graphite particle having an agglomerating property. The graphite is a hexagonal, hexagonal platelet crystal having a tortoiseshell-like layered structure, in which the carbons in the planes of each layer are bonded by a strong covalent bond, and the layers are bound by a weak van der Waals force. There is no particular restriction in the graphite particle, in which illustrative examples thereof include a scaly graphite, a scaly plate-like graphite, a granular graphite, and an amorphous graphite.

The average particle size of the graphite particle is preferably in the range of 1.0 to 8.0 μm. When the average particle size of the graphite particle is in the range of 1.0 to 8.0 μm, the surface area of the pigment in the coating resin layer increases, resulting in a high emissivity and an excellent bending processability. On the other hand, when the average particle size of the graphite particle is less than 1.0 μm, the advantageous effects on the bending processability is not increased any more, thereby leading to a possible increase in the production cost. When the average particle size of the graphite particle is more than 8.0 μm, the bending processability can be poor. The average particle size of the graphite particle is more preferably in the range of 1.0 to 5.0 μm. When the average particle size of the graphite particle is in the range of 1.0 to 5.0 μm, the emissivity increases furthermore. In the present invention, the graphite particle such as graphite exists in the form of a secondary particle, which is an agglomerate of primary particles, in the resin composition and in the coating resin layer. Note that the average particle size of the graphite particle refers to the average particle size of the secondary graphite particle. The average particle size of the secondary graphite particle is the particle size of the particle when the particle reaches the volume integration of 50% as measured by a laser diffraction method.

The content of the graphite particle in the coating resin layer is in the range of 5.0 to 25.0 parts by mass, and preferably in the range of 10.0 to 20.0 parts by mass, relative to a total of 100.0 parts by mass of the epoxy resin and the curing agent. By setting the content of the graphite particle in the coating resin layer within this range, it is possible to obtain a uniform coating resin layer having an excellent heat radiative property. On the other hand, when the content of the graphite particle in the coating resin layer is less than this range, an absolute amount of the graphite particle in the coating resin layer is insufficient, so that a poor heat radiation can be resulted, and when the content is above this range, it is impossible to obtain the uniform coating resin layer.

There is no particular restriction in the silica particle; illustrative examples thereof include a wet process silica and a dry process silica, in which a wet process silica is preferable. The wet process silica has a surface silanol group more than the dry process silica. The silanol group provides the filler with the reinforcing and adsorption functions. For the purpose of improving transparency and water resistance of the coating resin layer, the surface of the silica particle may be made hydrophobic by a silane or a silicone. When the coating resin layer comprises a hard silica particle, the coating resin layer becomes hard so that it is possible to improve the blocking resistance and hardness of the coating resin layer.

The content of the silica particle in the coating resin layer is in the range of 3.0 to 28.0 parts by mass, preferably in the range of 3.0 to 25.0 parts by mass, more preferably in the range of 5.0 to 18.0 parts by mass, and still more preferably in the range of 10.0 to 15.0 parts by mass, relative to a total of 100.0 parts by mass of the epoxy resin and the curing agent. The silica particle whose content in the coating resin layer is within this range brings about an excellent heat radiative property. On the other hand, when the content of the silica particle in the coating resin layer is less than 3.0 parts by mass, the heat radiation can be poor, and when the content is above this range, the alkali resistance becomes very low. In order to have an excellent alkali resistance, it is preferable that the content of the silica particle in the coating resin layer be 15.0 or less parts by mass relative to a total of 100.0 parts by mass of the epoxy resin and the curing agent.

The coating resin layer may comprise a wax in order to provide a lubricity. There is no particular restriction in the wax, but lanolin, a polyethylene wax, and a carnauba wax may be preferably used. The polyethylene wax having the number-average molecular weight of 600 to 12000 and the melting point of 80 to 130° C. is preferable. The carnauba wax is a vegetable wax comprising mainly a higher fatty acid ester; the carnauba wax having a melting point of 80 to 86° C. is preferable. The content of the wax in the resin composition layer is in the range of 1.0 to 15.0 mass %, and preferably in the range of 2.0 to 12.0 mass %, relative to a total of the epoxy resin and the curing agent.

The coating resin layer is the cured resin composition comprising the epoxy resin, the curing agent, the graphite particle, and the silica particle. The resin composition for forming the coating resin layer comprises, as the resin component, the epoxy resin and the curing agent, and as the filler, the filler comprising the graphite particle with an amount of 5.0 to 25.0 parts by mass relative to a total of 100.0 parts by mass of the epoxy resin and the curing agent and the silica particle with an amount of 3.0 to 28.0 parts by mass relative to a total of 100.0 parts by mass of the epoxy resin and the curing agent. The epoxy resin, the curing agent, the graphite particle, the silica particle, and the wax for the resin composition are the same as the epoxy resin, the curing agent, the graphite particle, the silica particle, and the wax for the coating resin layer.

Although the content of the curing agent in the resin composition may be selected as appropriate in accordance with the type of the epoxy resin, the epoxy equivalent weight, and the like, the content is preferably in the range of 0.5 to 11.0 parts by mass, and more preferably in the range of 0.5 to 7.0 parts by mass, relative to 100.0 parts by mass of the epoxy resin.

The content of the graphite particle in the resin composition is in the range of 5.0 to 25.0 parts by mass, and preferably in the range of 10.0 to 20.0 parts by mass, relative to a total of 100.0 parts by mass of the epoxy resin and the curing agent. The graphite particle whose content in the resin composition is within this range brings about the uniform coating resin layer having an excellent heat radiative property. On the other hand, when the content of the graphite particle in the resin composition is less than this range, an absolute amount of the graphite particle in the resin composition is insufficient, so that a poor heat radiation can be resulted, and when the content is above this range, it is impossible to obtain the uniform coating resin layer.

The content of the silica particle in the resin composition is in the range of 3.0 to 28.0 parts by mass, preferably in the range of 3.0 to 25.0 parts by mass, more preferably in the range of 5.0 to 18.0 parts by mass, and still more preferably in the range of 10.0 to 15.0 parts by mass, relative to a total of 100.0 parts by mass of the epoxy resin and the curing agent. The silica particle whose content in the resin composition is within this range brings about an excellent heat radiative property. On the other hand, when the content of the silica particle in the resin composition is less than 3.0 parts by mass, the heat radiation can be poor, and when the content is above this range, the alkali resistance becomes very low. In order to have an excellent alkali resistance, it is preferable that the content of the silica particle in the coating resin layer be 15.0 or less parts by mass relative to a total of 100.0 parts by mass of the epoxy resin and the curing agent.

The resin compositions may comprise a wax in order to provide a lubricity. Although there is no particular restriction in the wax, a polyethylene wax and a carnauba wax may be preferably used. The polyethylene wax having the number-average molecular weight of 600 to 12000 and the melting point of 80 to 130° C. is preferable. The carnauba wax is a vegetable wax comprising mainly a higher fatty acid ester; the carnauba wax having a melting point of 80 to 86° C. is preferable. The content of the wax in the resin composition is in the range of 1.0 to 15.0 mass %, and preferably in the range of 2.0 to 12.0 mass %, relative to a total of the epoxy resin and the curing agent. The average particle size of the wax is preferably in the range of 1 to 5 μm. When the average particle size of the wax is within this range, the wax tends to protrude from the surface of the coating resin layer when applied in a wet state because it is insoluble in a solvent. By drying and baking, the protruding portion on the surface melts so that the wax covers the surface of the coating resin layer, resulting in a uniform distribution of the wax. When the coating resin layer is formed of 2 or more layers of the cured resin composition, it is preferable that only the uppermost resin layer comprise the wax. The number-average molecular weight is measured using a gel permeation chromatography (GPC). The melting point is measured by the method in accordance with JIS K7121. The average particle size is measured by a laser diffraction and scattering method.

The resin composition may comprise a solvent. When the resin composition comprises a solvent, the epoxy resin, the curing agent, the graphite particle, the silica particle, and, if necessary, other component are dispersed or dissolved in the solvent. There is no particular restriction in the solvent; thus, illustrative examples thereof include water, an ester, a glycol ether, a glycol, a ketone, an aromatic hydrocarbon, an aliphatic hydrocarbon, and an alcohol. Among these solvents, specifically, xylene, toluene, and a mixture of these are especially preferable. The resin composition is prepared such that the content of solid components therein may be in the range of 1.0 to 50.0 mass %.

The coating resin layer is formed of the cured resin composition, in which the coating resin layer is formed by applying the resin composition to an aluminum alloy sheet with a prescribed thickness to form a coating layer of the resin composition followed by heating to cure the resin composition.

The thickness of the coating resin layer is preferably in the range of 2.0 to 25.0 μm. The coating resin layer having the thickness within this range brings about a high emissivity and an excellent processability. In view of exhibiting a better heat radiation, the thickness of the coating resin layer is preferably in the range of 5.0 to 25.0 μm. In view of a better coating property, the thickness of the coating resin layer is preferably in the range of 5.0 to 15.0 μm. In view of a higher alkali resistance, the thickness of the coating resin layer is preferably 5.0 μm or more, and in view of a further higher alkali resistance, the thickness is more preferably 10.0 μm or more. When the coating resin layer is formed of 2 or more resin layers, the thickness of the coating resin layer refers to a total thickness of all the resin layers.

The coating resin layer may consist of one resin layer, 2 resin layers, or 3 or more resin layers. When the coating resin layer consists of 2 or more resin layers, each resin layer may all consist of the same cured resin composition, or may consist of different cured resin compositions within the composition range of the resin composition for the resin-coated aluminum alloy sheet according to the present invention. When the coating resin layer consists of 2 resin layers, the thickness of the upper layer is preferably in the range of 3.0 to 10.0 μm, and the thickness of the lower layer is preferably in the range of 3.0 to 10.0 μm. The thickness of the coating resin layer is measured by a strand gauge, an electromagnetic film thickness meter, an eddy current film thickness meter, a gravimetric method, or the like.

The arithmetic mean roughness of the surface of the coating resin layer is preferably in the range of 0.7 to 2.5 μm, and more preferably in the range of 1.2 to 2.3 μm. The surface roughness of the coating resin layer within this range increases the surface area of the coating surface and the emissivity.

The surface glossiness of the coating resin layer is preferably in the range of 0.1 to 4.5, and more preferably in the range of 0.3 to 2.0. The glossiness of the coating resin layer within this range brings about a high emissivity. The glossiness of the coating resin layer within this range enhances the heat radiative property because the surface roughness of the coating film increases thereby leading to an increase in the surface area of the coating film.

The emissivity of the coating resin layer is preferably in the range of 0.70 to 0.95, more preferably in the range of 0.80 to 0.95, and still more preferably in the range of 0.80 to 0.95. The emissivity of the coating resin layer within this range brings about an enhancement in the heat radiative property.

The following method may be used to form the coating resin layer, for example. First, a coating material (resin composition) is prepared as follows. Namely, the epoxy resin and the curing agent are mixed in the solvent; then, after the graphite and silica particles are added, all the ingredients are dissolved or dispersed in the solvent. Next, the resulting coating material (resin composition) is applied directly to the surface of the aluminum alloy sheet or on the chemical conversion coating film formed on the surface of the aluminum alloy sheet, which is then followed by processing the material in an oven at a predetermined temperature and for a predetermined time for drying and baking to form a coating film of the resin composition, so that the coating film of the resin composition is further cured. With this, the coating resin layer is formed. There is no particular restriction in the solvent, thus, illustrative examples thereof include water, an ester, a glycol ether, a glycol, a ketone, an aromatic hydrocarbon, an aliphatic hydrocarbon, and an alcohol. Among these, specifically, xylene, toluene, and a mixture of these are particularly preferable. In general, the coating material is prepared so as to give the solid content of 1 to 50 mass %.

To form the coating resin layer consisting of 2 resin layers, the coating material (resin composition) is applied directly to the surface of the aluminum alloy sheet or on the chemical conversion coating film formed on the surface of the aluminum alloy sheet, which is then followed by processing in an oven at a predetermined temperature and for a predetermined time for drying and baking to form the lower resin layer; then, the coating material (resin composition) is applied to the surface of the lower resin layer, processed in an oven at a predetermined temperature and for a predetermined time for drying and baking. With this, the upper resin layer is formed.

There is no particular restriction in the application method of the coating material (resin composition); thus, illustrative examples thereof include a roll coater method, a roll squeeze method, an air knife method, a chemicoater method, a dip method, a spray method, and a bar coater method. The most suitable method to form the coating resin layer on the aluminum alloy sheet at a low cost is to continuously apply the coating material (resin composition) with a roll coater using a coil. When the coating material is applied by this method, for example, the coating material is baked in a baking furnace divided into 3 to 7 zones. The total baking time of 10 to 60 seconds is preferable, and the total baking time of 20 to 45 seconds is more preferable. The maximum temperature in baking is preferably in the range of 200 to 290° C.

When forming a thick coating resin layer having the thickness of 10.0 to 25.0 μm, in order to form the thick coating resin layer in a single application, the thickness of the resin composition to be applied needs to be increased. However, when the resin composition layer is thick, evaporation of the solvent from the resin composition after application is difficult, so that the curing of the resin prevents the solvent from evaporation, whereby flatness of the coating surface can be impaired. Therefore, when forming the thick coating resin layer, it is preferable to first form a lower resin layer having the thickness of 3.0 to 15.0 μm by using the resin composition, followed by the formation of an upper resin layer having the thickness of 3.0 to 15.0 μm; in this way, prevention of evaporation of the solvent is suppressed, so that it is possible to suppress surface irregularity of the coating film.

The resin composition for the resin-coated aluminum alloy sheet according to the present invention comprises an epoxy resin, a curing agent, a graphite particle with an amount of 5.0 to 25.0 parts by mass, preferably 10.0 to 20.0 parts by mass relative to a total of 100.0 parts by mass of the epoxy resin and the curing agent, a silica particle with an amount of 3.0 to 28.0 parts by mass, preferably 3.0 to 25.0 parts by mass, more preferably 5.0 to 18.0 parts by mass, still preferably 10.0 to 15.0 parts by mass relative to a total of 100.0 parts by mass of the epoxy resin and the curing agent, and a solvent. The resin composition for the resin-coated aluminum alloy sheet according to the present invention may also comprise, if necessary, 1.0 to 15.0 mass %, preferably 2.0 to 12.0 mass % of the wax relative to a total of the epoxy resin and the curing agent.

The resin composition for the resin-coated aluminum alloy sheet according to the present invention is the resin composition to form the coating resin layer on the aluminum alloy sheet, in which the resin composition is applied to the surface of the aluminum alloy sheet directly or on a chemical conversion coating film formed on the surface of the aluminum alloy sheet to form a coating film of the resin composition, which is then followed by curing the coating film of the resin composition. The resin composition for the resin-coated aluminum alloy sheet according to the present invention is the resin composition for the aluminum alloy sheet coated with the heat-dissipating resin.

The epoxy resin, the curing agent, the graphite particle, the silica particle, the solvent, and the wax relating to the resin composition for the resin-coated aluminum alloy sheet according to the present invention are the same as the epoxy resin, the curing agent, the graphite particle, the silica particle, the solvent, and the wax relating to the resin composition in the resin-coated aluminum alloy sheet according to the present invention.

Next, the present invention will be described more specifically by means of Examples; however, these are merely illustrative and do not limit the present invention.

### EXAMPLES

### Examples 1 to 12, and Comparative Examples 1 to 2

After an aluminum alloy sheet (material: JIS A1050, thickness of 0.6 mm) was degreased with a commercially available degreasing agent for aluminum, this was rinsed and chemically treated with a commercially available phosphate chromate treatment solution to form a chemical conversion coating film.

Next, an epoxy resin and an amine type curing agent (resin component), a heat-dissipating particle, and a silica particle (wet process silica) were added to an organic solvent (a mixture of toluene, methyl ethyl ketone, and cyclohexanone), as described in Table 1, which was then followed by dispersion or dissolving to prepare a coating material. The resulting coating material was applied by a bar coater method to one surface of the aluminum alloy sheet on which the chemical conversion coating film had been formed, which was then followed by baking in a hot air oven to form a coating resin layer. The baking conditions were as follows: the maximum temperature was 272° C. and the baking time was 84 seconds. In Example 12, the double coating method was used to form first a lower resin layer, followed by an upper resin layer.

The amount of Cr in the chemical conversion coating film was found to be 20 to 30 g/m² by measurement with an X-ray fluorescence method. The thickness of the coating resin layer after drying was measured with an eddy current film thickness meter, and the results thereof are listed in Table 1.

### (Test Method)

The resin-coated aluminum alloy sheets obtained were subjected to the performance tests using the following test methods.

### (Emissivity)

The emissivity of the surface of the coating resin layer was measured using a portable emissometer (D and SAERD, manufactured by Kyoto Electronics Manufacturing Co., Ltd.) in accordance with the standard ASTM C1371 (Standard Test Method for Measuring Emittance of Materials near Room Temperature Using a Portable Emissometer).

### (Glossiness)

The glossiness of the surface of the coating resin layer was measured using a handy gloss meter (IG-410, manufactured by Horiba, Ltd.).

### (Bending Processability)

The bending processability was evaluated by bending the coating resin layer in accordance with the 180° 3T bending test, in which the crack of the coating resin layer was visually evaluated on the basis of the following criteria: 1: no cracks in the coating resin layer, 2: good in spite of minor cracks in the coating resin layer, 3: usable in spite of small cracks in the coating resin layer, 4: unusable because of significant cracks in the coating resin layer.

(Tape Test) A cross-cut adhesion test in accordance with JIS K5400 was conducted as the adhesion test. The virgin material (no treatment after coating) and the material after the high temperature and high humidity test (120° C., 96 hours) were used as the test materials. The test method was as follows. Namely, after 100 squares with 1 mm×1 mm (11 squares vertically and horizontally) were created in the specimen by notching using a cutter knife, a cellophane tape was adhered to this; then, the number of the squares not peeled-off from the coating film was counted.

### (Chemical Resistance Test)

The immersion test in accordance with JIS K5600-6-1 was conducted for the chemical resistance test. An aqueous 5 mass % sodium hydroxide solution and an aqueous 5 mass % sulfuric acid solution were used as the immersion solutions. The specimen was immersed in the immersion solution for 24 hours, and after immersion, the specimens were rinsed and dried. The condition of the coating film was visually evaluated on the basis of the following criteria: 1: no peeling of the coating film, 2: good with slight peeling, 3: usable in spite of minor peeling, 4: unusable with significant peeling.

### (Arithmetic Mean Roughness Ra of Coating Resin Layer Surface)

The arithmetic mean roughness Ra (μm) of the surface of the resin layer of the resin-coated aluminum alloy sheet was measured in accordance with JIS B0601.

### (Measurement of Average Particle Size of Graphite Particle)

The particle size distribution and average particle size (D50, the particle size when the particles reach 50% volume integration) were calculated by a laser diffraction method.

The obtained performance test results are listed in Table 1. In Table 1, the addition amount is described in terms of parts by mass of the ingredient to a total of 100.0 parts by mass of the epoxy resin and the curing agent.

TABLE 1

| | Resin | | Heat-dissipating | | | | | |
|---|---|---|---|---|---|---|---|---|
| | component | | particle | | | Silica particle | | Coating |
| | | Amount | | | Amount | | Amount | resin |
| | | (parts | | Particle | (parts | Particle | (parts | layer |
| | | by | | size | by | size | by | thickness |
| | Resin | mass) | Particle | (μm) | mass) | (μm) | mass) | (μm) |
| Example | | | | | | | | |
| 1 | A | 100.0 | A1 | 3.0 | 10.0 | 0.2 | 14.0 | 10.0 |
| 2 | A | 100.0 | A1 | 3.0 | 15.0 | 0.2 | 14.0 | 10.0 |
| 3 | A | 100.0 | A1 | 3.0 | 20.0 | 0.2 | 14.0 | 10.0 |
| 4 | A | 100.0 | A1 | 3.0 | 15.0 | 0.2 | 5.0 | 10.0 |
| 5 | A | 100.0 | A1 | 3.0 | 15.0 | 0.2 | 10.0 | 10.0 |
| 6 | A | 100.0 | A1 | 3.0 | 15.0 | 0.2 | 20.0 | 10.0 |
| 7 | A | 100.0 | A1 | 3.0 | 15.0 | 0.2 | 25.0 | 10.0 |
| 8 | A | 100.0 | A1 | 3.0 | 15.0 | 0.2 | 14.0 | 2.0 |
| 9 | A | 100.0 | A1 | 3.0 | 15.0 | 0.2 | 14.0 | 5.0 |
| 10 | A | 100.0 | A1 | 3.0 | 15.0 | 0.2 | 14.0 | 15.0 |
| 11 | A | 100.0 | Al | 3.0 | 15.0 | 0.2 | 14.0 | 25.0 |
| 12 | A | 100.0 | A1 | 3.0 | 15.0 | 0.2 | 14.0 | Upper |
| | | | | | | | | layer: 2.0 |
| | | | | | | | | Lower |
| | | | | | | | | layer: 6.0 |
| Comparative | | | | | | | | |
| Example | | | | | | | | |
| 1 | B | 100.0 | B | 3.0 | 7.0 | 0.2 | 14.0 | 13.0 |
| 2 | A | 100.0 | C | 3.0 | 27.0 | 1.5 | 10.0 | 10.0 |
| | Characteristics of coating resin film | | | | | | | |
| | | | | | Cross-cut | | | |
| | | | | | peeling test | | | |
| | | | | | | After | | |
| | | | | | | constant | | |
| | Surface | | | | | temp./ | Chemical | |
| | roughness | | Emissivity | | | humidity | resistance | |
| | (Ra) | Glossiness | (%) | Processability | Initial | test | Acid | Alkali |
| Example | | | | | | | | |
| 1 | 1.953 | 1.3 | 0.88 | 1 | 100/100 | 100/100 | 1 | 2 |
| 2 | 2.169 | 0.6 | 0.90 | 1 | 100/100 | 100/100 | 1 | 2 |
| 3 | 2.216 | 0.3 | 0.92 | 1 | 100/100 | 100/100 | 1 | 2 |
| 4 | 1.286 | 3.6 | 0.87 | 1 | 100/100 | 100/100 | | 2 |
| 5 | 1.733 | 1.5 | 0.90 | 1 | 100/100 | 100/100 | 1 | 2 |
| 6 | 1.958 | 0.3 | 0.93 | 1 | 100/100 | 100/100 | 1 | 4 |
| 7 | 1.839 | 0.3 | 0.95 | 1 | 100/100 | 100/100 | 1 | 4 |
| 8 | 0.881 | 4.1 | 0.70 | 1 | 100/100 | 100/100 | 1 | 4 |
| 9 | 1.383 | 1.2 | 0.87 | 1 | 100/100 | 100/100 | 1 | 3 |
| 10 | 1.873 | 0.9 | 0.91 | 1 | 100/100 | 100/100 | 1 | 2 |
| 11 | 2.093 | 0.9 | 0.91 | 1 | 100/100 | 100/100 | 1 | 2 |
| 12 | 1.526 | 0.3 | 0.91 | 1 | 100/100 | 100/100 | 1 | 2 |
| Comparative | | | | | | | | |
| Example | | | | | | | | |
| 1 | 1.169 | 5.4 | 0.90 | 1 | 100/100 | 0/100 | 1 | 4 |
| 2 | 0.621 | 1.4 | 0.66 | 1 | 100/100 | 100/100 | 1 | 2 |

### Examples 13 to 16

After an aluminum alloy sheet (material: JIS A1050, thickness of 0.6 mm) was degreased with a commercially available degreasing agent for aluminum, this was rinsed and chemically treated with a commercially available phosphate chromate treatment solution to form a chemical conversion coating film.

Next, an epoxy resin and an amine type curing agent (resin component), a heat-dissipating particle, and a silica particle (wet process silica) were added to an organic solvent (a mixture of toluene, methyl ethyl ketone, and cyclohexanone), as described in Table 2, which was then followed by dispersion or dissolving to prepare a coating material. The resulting coating material was applied by a bar coater method to one surface of the aluminum alloy sheet on which the chemical conversion coating film had been formed, which was then followed by baking in a hot air oven to form a coating resin layer. The baking conditions were as follows: the maximum temperature was 272° C. and the baking time was 84 seconds.

The amount of Cr in the chemical conversion coating film was found to be 20 to 30 g/m² by measurement with an X-ray fluorescence method. The thickness of the coating resin layer after drying was measured with an eddy current film thickness meter, and the results thereof are listed in Table 2.

The emissivity of the resulting resin-coated aluminum sheet was measured. The results are listed in Table 2.

TABLE 2

| | | | | | | | | Characteristics |
|---|---|---|---|---|---|---|---|---|
| | Resin component | | Heat-dissipating particle | | | Silica particle | | of coating |
| | | Amount | | Particle | Amount | Particle | Amount | resin film |
| | | (parts by | | size | (parts by | size | (parts by | Emissivity |
| Example | Resin | mass) | Particle | (μm) | mass) | (μm) | mass) | (%) |
| 13 | A | 100.0 | A1 | 3.0 | 15.0 | 0.2 | 14.0 | 0.90 |
| 14 | A | 100.0 | A2 | 5.0 | 15.0 | 0.2 | 14.0 | 0.88 |
| 15 | A | 100.0 | A3 | 7.0 | 15.0 | 0.2 | 14.0 | 0.85 |
| 16 | A | 100.0 | A4 | 8.0 | 15.0 | 0.2 | 14.0 | 0.80 |

The resins in Tables 1 and Table 2 are as follows.
A: Epoxy resin (molecular weight of 50000) and amine type curing agent
B: Polymer Polyester

The heat-dissipating grains in Table 1 and Table 2 are as follows.
A1: Graphite particle: average particle size of 3.0 μM,
A2: Graphite particle: average particle size of 5.0 μm
A3: Graphite particle: average particle size of 7.0 μm
A4: Graphite particles: average particle size of 8.0 μm
B: Conventional graphite particle
C: Carbon black

### DESCRIPTION OF NUMERICAL SYMBOLS

1 Resin-coated aluminum alloy sheet
2 Aluminum alloy sheet
3 Chemical conversion coating film
4 Coating resin layer

1. A resin-coated aluminum alloy sheet, comprising a coating resin layer formed of a cured resin composition comprising an epoxy resin and a curing agent,
the coating resin layer comprising a graphite particle with an amount of 5.0 to 25.0 parts by mass relative to a total of 100.0 parts by mass of the epoxy resin and the curing agent and a silica particle with an amount of 3.0 to 28.0 parts by mass relative to a total of 100.0 parts by mass of the epoxy resin and the curing agent, and a thickness of the coating resin layer being 2.0 to 25.0 μm.

2. The resin-coated aluminum alloy sheet according to claim 1, wherein the coating resin layer is formed of a cured resin composition comprising, as a resin component, the epoxy resin and the curing agent, and, as a filler, the graphite particle with an amount of 5.0 to 25.0 parts by mass relative to a total of 100.0 parts by mass of the epoxy resin and the curing agent and the silica particle with an amount of 3.0 to 28.0 parts by mass relative to a total of 100.0 parts by mass of the epoxy resin and the curing agent.

3. The resin-coated aluminum alloy sheet according to claim 1, wherein a molecular weight of the epoxy resin is in a range of 40000 to 60000.

4. The resin-coated aluminum alloy sheet according to claim 1, wherein the curing agent is an amino resin type curing agent.

5. The resin-coated aluminum alloy sheet according to claim 1, wherein a thickness of the coating resin layer is in a range of 5.0 to 15.0 μm.

6. The resin-coated aluminum alloy sheet according to claim 1, wherein an average particle size of the graphite particle is in a range of 1.0 to 8.0 μm.

7. The resin-coated aluminum alloy sheet according to claim 6, wherein the average particle size of the graphite particle is in a range of 1.0 to 5.0 μm.

8. The resin-coated aluminum alloy sheet according to claim 1, wherein an arithmetic mean roughness Ra of a surface of the coating resin layer is in a range of 0.100 to 2.500 μm.

9. The resin-coated aluminum alloy sheet according to claim 1, wherein a glossiness of the coating resin layer is in a range of 0.1 to 4.5.

10. A resin composition for a resin-coated aluminum alloy sheet, the resin composition comprising an epoxy resin, a curing agent, a graphite particle with an amount of 5.0 to 25.0 parts by mass relative to a total of 100.0 parts by mass of the epoxy resin and the curing agent, a silica particle with an amount of 3.0 to 28.0 parts by mass relative to a total of 100.0 parts by mass of the epoxy resin and the curing agent, and a solvent.
